(19) United States
(12) Patent Application Publication
(10) Pub. No.: US 2007/0194256 A1
(43) Pub. Date: Aug. 23, 2007

(54) Multifunctional radiation shield for space and aerospace applications

(75) Inventors: David J. Srobel, (US); Philip J. Layton, (US); Carl S. Edwards, (US); Michael Featherby, (US)

Correspondence Address: SPACE MICRO INC., SUITE 400, 10401 ROSELLE STREET, SAN DIEGO, CA, 92121-1526, US

(73) Assignee: SPACE MICRO, INC.

(21) Appl. No.: 11/784,600

(22) Filed: Apr. 9, 2007

Related U.S. Application Data
(63) Continuation-in-part of application No. 11/431,474, filed on May 10, 2006.
(60) Provisional application No. 60/679,537, filed on May 10, 2005.

(51) Int. Cl. G21F 3/00

(52) U.S. Cl. 250/515.1

(57) ABSTRACT

Embodiments of the invention comprise a filler to block the radiation, and an organic resin, such as epoxy or modified cyanate ester. Fillers may comprise passivated Gadolinium and Tungsten. The Gadolinium may be passivated by atomic deposition of a nano-layer of silica or alumina. The passivation layer reduces the chemical activity of the filler while retaining the maximum attenuation performance of the pure metal. Radiation performance is optimized by reaching optimum material density, as density is proportional to radiation attenuation performance. The proportion of passivated Gadolinium to Tungsten may be selected based on the radiation shielding performance and environment for such species as X-ray, thermal neutrons, gamma and cosmic rays.

### CROSS REFERENCE TO RELATED APPLICATIONS

This application is a Continuation in Part of and claims priority from U.S. patent application Ser. No. 11/431,474 filed May 10, 2006, the contents of which are hereby incorporated by reference in their entirety. This application also claims priority from provisional patent applications 60/789,252, filed Apr. 6, 2006, 60/835,711, filed Aug. 7, 2006, the disclosures of which are incorporated by reference herein.

### FIELD OF THE INVENTION

The present subject matter relates to an optimized radiation shielding material, shields comprising the material and to structures incorporating such shields. Protection from types of various types of radiation including, for example forms of radiation expected to be encountered in space related or high altitude.

### BACKGROUND OF THE INVENTION

Many fields benefit from radiation shielding, including space related or high-altitude applications. Prior art radiation shielding materials include Boron, Tungsten, Titanium, Tantalum, Gadolinium, Hafnium, Osmium, Platinum, Gold, Silver, or Palladium or some combination of these.

Earlier materials, such as RAD-COAT™ or RAD-PAK™, either placed a coating directly on the semiconductor die or package or utilized shields made of a gold plated Tungsten-Copper alloy. Foil shielding, however, when incorporated into the walls of space vehicles, are prone to mechanical failure during use, as the adhesive bond between the metal and the organic adhesive of the composite is susceptible to thermal expansion mismatch between the metal and the adhesive. Further the bonds between dissimilar materials are not as robust as bonds between like materials. In the invention, having the matrix material in the shield either match or be chemically compatible with the composite construction of the spacecraft mitigates this. The matrix adhesive in the shield can bond chemically with the adhesive in the walls of the spacecraft, forming a truly mechanically integrated structure.

There is a need for a radiation shield that can be an integral part of the space craft construction that will not compromise the mechanical performance of the spacecraft; which is compatible with the assembly processes associated with said construction; which is easy to fabricate and which can address the radiation shielding needs of the application.

### SUMMARY OF THE INVENTION

Briefly stated, in accordance with embodiments of the present invention, a radiation shielding material comprising a mixture of Tungsten and of a neutron attenuator. Gadolinium and Boron are preferred neutron attenuators. The Gadolinium may be passivated to facilitate its handling. A nano-layer coating may comprise silica or alumina formed by atomic deposition. The passivation layer reduces the chemical activity of the filler while retaining the maximum attenuation performance of the pure metal. A shield comprises the Tungsten-passivated Gadolinium mixture in a binder such as epoxy which may be partially or wholly cured. A structure may be constructed that is integral with the shield.

### BRIEF DESCRIPTION OF THE DRAWINGS

The drawings consist of Drawing 1, FIGS. 1 and 2 and Graphs 1-4.

### DETAILED DESCRIPTION OF THE PREFERRED EMBODIMENTS

Embodiments of this invention exhibit, through the use of modeling, improved attenuation of Black Body X-rays, while also providing significant thermal neutron attenuation through the selection a filler comprising two metals when compared with similar shields fabricated with the use of one filler, e.g., Tungsten.

Embodiments of the invention specifically address the issues of shielding Blackbody X-ray radiation in the 1 keV to 10 keV range in Aerospace structures such as planes, interceptors, UAVs, spacecraft, missiles and satellites. Besides X-ray shielding, the material addresses 1) Thermal issues associated with high temperature in space, and more specifically that short intense thermal shock caused by burst of Black Body X-rays and 2) mechanical strength required for high stress environments of space.

The embodiments comprise a radiation shield filler composition providing both high Z and effective neutron attenuation. Boron and Gadolinium are effective neutron attenuators in that their attenuation performance is materially higher than other metals. Tungsten is more dense. One form of the material is a composite which is comprised of Tungsten and Gadolinium in a binder material using resins. The Gadolinium may be passivated. A radiation-shield composition according Atomic deposition may be used to form a nano-layer of silica or alumina. The passivation layer reduces the chemical activity of the filler while retaining the maximum attenuation performance of the pure metal. Other compositions also exist and the optimum percentage of tungsten and gadolinium depends on the energy of X-rays. Boron may alternatively be used as a neutron attenuator. Boron has lower density,

In embodiments of the invention the resin in the Tungsten composite acts as an integral low Z material so that no separate absorber is required. Other fillers can be substituted for a portion of the Tungsten for different environments, such as Gadolinium or Boron for neutron shielding. Further, thickness variations can be made to optimize the spatial shielding efficiency (and weight). Powder mixtures and powder gradients are possible which provide the best overall reduction of the various forms of radiation. The lack of sharp interfaces eliminates the thermal spikes that can occur at these locations.

Embodiments of the invention in one form comprise a filler to block the radiation. The filler comprises metals in a binder, preferably an organic resin, such as epoxy or cyanate ester. The proportion of metals in the filler may be selected based on the radiation shielding performance and environment for such species as X-ray, neutron, gamma and cosmic rays. Radiation performance may be optimized for each type of radiation environmental requirement and is proportional to radiation attenuation. Additionally, the formulation may employ additives such as fumed silica and various solvents to facilitate rheological modifications during processing.

In another form, the filler further comprises an adhesive so that a shield may be affixed to another structure without application of a separate adhesive layer. The adhesive may comprise the binder. An exemplary adhesive binder is epoxy which has been partially, e.g., 60%, cured.

Another embodiment comprises a shield comprising the filler. The shield by be heated to a temperature greater than T_{g}, a glass transition temperature, and shaped. The shape will be retained when the temperature decreases below T_{g}. Further, a structure integrally including the shield may also be provided.

Embodiments of the invention can use a broader array of fillers than the foil approach. While Tungsten is the preferred shielding material for many radiation environments, Tungsten in sheet and foil is very difficult to work with because of its brittleness. Joining is equally difficult because if its refractoriness, poor solder-ability and oxidation resistance. Embodiments of the invention address this problem by using powder fillers. The powder, combined with a resin matrix is easier to shape and process but still yields high enough density to provide effective radiation shielding.

Embodiments of the invention also permit the incorporation of various sensor devices within its structure to enable real time monitoring of the spacecraft health for such parameters as temperature, radiation, and pressure. This refers to the ability of embodiments of the invention to perform as a “smart composite.”

The shielding material is embedded in a flexible fiber reinforced carbon based matrix so that it can it can be applied as a B-stage to allow placement in non-planar structures and be co-processed with the overall assembly of an aerospace vehicles skin. The process allows for brittle materials that have good shielding properties to be used. The processing is compatible with composites technology and uses adhesives that are chemically and mechanically compatible with the composite. Since it bonds with the composite, it forms an integral part of the structure to yield excellent adhesion at the attachment surfaces.

Dispersing the powders in a polymer eliminates the potential for residual thermal stresses between the fiber reinforced composite and the high modulus metal coating with dissimilar coefficients of thermal expansion. These stresses can unbalance the structure or cause de-lamination of foil technologies.

This technology provides for great application and manufacturing flexibility. A flat substrate will allow the coating to be doctor bladed on at the required thickness. Coatings on curved and complex surfaces can be achieved, either by fabricating a flexible tile or stenciling the material into a location within the composite structure. With the proper choice of adhesive, the material can be cured into the composite, resulting in strong interface adhesion. This will produce a laminate of powder and uncured resin in a controlled thickness sheet that can be stacked for greater attenuation. Layers can be built up with a mix of shielding materials to further improve attenuation performance.

Another configuration option includes fabrication of a decal that can be placed in a transfer carrier. The resin can be ‘B’ staged for easy attachment to the structural base. Co-curing or a separate cure is then possible. Producing the material in a sheet allows the use of pressure to consolidate the powder for greater compaction and a higher final density/efficiency. A sample composition of the material is provided below in table 1.

TABLE 1
Compositional Example of Black body X-ray, neutron shield
Note that the percentages of Tungsten and Gadolinium expressed
below are percentages of the metal mixture. Percentages of resin
and rheological filler are percentages of volume of the shield.

| Component | Percentage by weight |
|---|---|
| Tungsten | 30-97 |
| Gadolinium | 3-70 |
| Organic Resin | 1-5 |
| Rheological filler | 0-5 |

As will be seen with respect to FIG. 1, attenuation of radiation at each of a number of radiation levels is improved with a Gadolinium concentration of 20%-40% compared to proportions outside this range. This range provides for optimization of thermal neutron absorption and of X-ray attenuation. A further preferred range is 23%-37%. However, much higher proportions of Gadolinium may be provided. The Gadolinium and Tungsten need not be provided in separate layers, but may be provided as a mixture of powders.

Radiation Optimization.

The actual percentages of materials for selected applications may be based on modeling the intended environment. For the natural space environment, a low Z, high Z material with a final low Z material is optimum for proton and electron shielding. The final low Z material absorbs the secondary particles generated from the high Z materials. This is optimized in embodiments of the invention compound using finite particles intermixed with High Z material and Low Z resin binders.

For Black Body radiation, ratios of the high Z material can be optimized for the shielding certain blackbody X-rays which is a function of the actual blackbody temperature.

As an example, the optimum amount of Gadolinium to reduce the blackbody photon radiation varies with the blackbody temperature. FIG. 1 show the graph of dose rate after shielding using various amounts of Gd with the total amount of Gd/W composite shielding equal to 100 mils. This can be equated to the percentage of Gd in the compound structure as shown in FIG. 2.

Dose from Other Materials

Different materials were evaluated for shielding properties in combination with the tungsten composite (density of 13.2 gm/cm³)

TABLE 2
Dose rate (rad/sec) 80 mil W composite (13.2 gm/cm³) and 20 mils of various materials in
0.1 cal/cm2, 30 ns FWHM environment for 3 Black Body Spectra

| Temp keV | Al | Ti | Ag | Cu | Pd | Os | Gd | None |
|---|---|---|---|---|---|---|---|---|
| 3 | 5.02E+02 | 4.49E+02 | 3.71E+01 | 2.83E+02 | 3.12E+01 | 1.48E+01 | 1.05E+01 | 5.10E+02 |
| 5 | 2.50E+05 | 2.27E+05 | 2.23E+04 | 1.49E+05 | 1.89E+04 | 9.19E+03 | 5.60E+03 | 2.54E+05 |
| 10 | 1.16E+07 | 1.07E+07 | 1.81E+06 | 7.49E+06 | 1.64E+06 | 6.41E+05 | 8.82E+05 | 1.17E+07 |

20 mils of material was added to 80 mils of W composite with a 13.2 gm/cm³ density. As can be seen by comparing Al to None (only 80 mil of the W composite, no additional material), Al provides very little attenuation for any of the black body spectra. Osmium (Os) is the best theoretically as the most dense material, but is not a practical choice due to its cost. As can be seen, other materials can be used and still meet the required dose reduction and may have other optimal properties like thermal conductivity or melting temperature.

Changing the Material Density and Thickness

For optimum material properties the amount of the high Z material used in this case Tungsten can be reduced and still provide an effective shield. A Tungsten composite with a density of 11.4 gm/cm³ is shown for dose rate at two thicknesses (60 mils and 100 mils), two fluences (0.1 and 0.5 cal/cm²) and 3 black body temperatures (3, 5 and 8 keV). Table 3 and 4 show the results of these calculations.

TABLE 3
0.1 cal/cm² dose rate (rad/sec) for various black body X-ray
spectra and thickness' of a W-composite with a density
of 11.4 gm/cm³

| BB Temp | | | |
|---|---|---|---|
| keV | 0 mils | 60 mil | 100 mils |
| 3 | 1.9E+14 | 1.3E+4 | 2.7E+2 |
| 5 | 6.2E+13 | 4.2E+6 | 1.4E+5 |
| 8 | 2.1E+13 | 7.9E+7 | 3.9E+6 |

TABLE 4
0.5 cal/cm² dose rate (rad/sec) for various black body X-ray spectra
and thickness' of a W-composite with a density of 11.4 gm/cm³

| BB Temp | | | |
|---|---|---|---|
| keV | 0 mils | 60 mil | 100 mils |
| 3 | 9.5E+14 | 6.6E+4 | 1.3E+3 |
| 5 | 3.1E+14 | 2.1E+7 | 7.0E+5 |
| 8 | 1.0E+14 | 393E+06 | 1.9E+7 |

Typical commercial parts will survive up to dose rates of 1E8 rad/sec, therefore 60 mils of the 11.4 gm/cm³ W composite should be sufficient for a 0.1 cal/cm² fluence threat while additional shielding would be required for 0.5 cal/cm² threats for the hotter 8 keV Blackbody spectrum.

This enables use of commercially available semiconductor parts in new defense systems.

Using known dose rate susceptible parts would allow for less shielding. For a large number of parts with unknown susceptibility a thicker shield would be required.

Configuration Comparisons

Summary:

Several examples of material configurations for radiation shielding can be seen in Table 5.

TABLE 5
Shield Material Configurations

| Configuration | Source/Description |
|---|---|
| 1. Filled Composite | Hi Z/Lo Z composite approach. Tungsten filled |
| (Space Micro) | epoxy composite. 70% theoretical density. |
| 2. Blended Filled | Hi Z/Lo X composite approach. Single or Multiple |
| Composite | filler composite. >70% theoretical density. |
| (Space Micro) | |

Modeling Performance Comparisons

Configuration 1: 95 mils Tungsten/5 mils Gadolinium/Organic Resin Composite,

Configuration 2: 80 mils Tungsten/20 mils Gadolinium/Organic Resin Composite.

Modeling performance for X-ray shielding attenuation is seen below. Using 3 KeV blackbody X-ray. Using nominal 100 mil (0.100″) thickness for both composite structures, these models both show eleven orders of magnitude attenuation in Dose Deposition through the sample as seen in Graphs 1 and 2.

The differences between configuration three and four are the use of a single filler versus blended fillers. Where a single filler system might be effective at blocking one radiation species, such as X rays, blended fillers provide the advantage of shielding multiple radiation species, for example, in the case of configuration 4, both X rays and neutrons.

Note that the models use a 70% of theoretical density for Tungsten. For both configuration 3 and configuration 4, there is almost complete attenuation.

In terms of application, embodiments of the invention offer advantages over current technologies. Complex shapes are difficult to conform to with brittle and stiff foils. Embodiments of the invention is designed to be process flexible, as it can be applied as a paste, a stencil or B-stage to allow placement in non-planar structures and be co-processed with the overall assembly. The processing is compatible with composites technology as it uses adhesives that are chemically and mechanically compatible with the composite. Since it bonds with the composite, it forms an integral part of the structure to yield excellent adhesion at the attachment surfaces. A comparison of radiation blocking technologies can be seen in Table 6.

TABLE 6
Comparison of radiation shielding technologies

| | “embodiments | | |
|---|---|---|---|
| | of the | | |
| PARAMETER | invention” | RADCOAT ™ | METAL FOILS |
| Location | Anywhere in | Put over | Anywhere in |
| | composite | electronics only | composite |
| Mechanical | Excellent | Excellent | Acceptable |
| Performance | | | |
| Effectiveness | Excellent | Excellent | Excellent |
| Mfg | Process flexible | Separate process | Less compatible |
| Compatibility | | | |
| Rad. Attenuation | Superior | Excellent | Excellent |
| Format | Highly Flexible | Direct on | Brittle |
| | | electronics | |
| Versatility | All vulnerable | Electronics | All vulnerable |
| | hardware | | hardware |

Radiation Modeling Evaluation of Shielding Material

Shielding material: The shielding material is 63 mil thick (0.16 cm) and is comprised of 80% W and 20% Gd in a composite. The overall density is 11.4 gm/cm³. Also compared was a pure W in a composite also with a density of 11.4 gm/cm³. Additionally POSS (Polyhedral oligomeric silsesquioxane) with a single Gd atom was modeled. POSS has 8 Si atoms with 12 O atoms and one Gd atom per molecule. The molecular weight of POSS is 605 gm/mole.

Assumptions:

THTK 3.0 was used to model x-ray attenuation of 4 different blackbody temperatures between 3 and 10 keV. The pulse shape was 10 ns with a 30 ns FWHM. The X-ray total peak fluence was 0.1 cal/cm². FIGS. 1 and 2 shows two attenuation curves (3 keV and 10 keV). Because THTK can't model compounds, the modeling was performed using two layers 50.4 mils of W composite with a density modified to 11.4 gm/cm³ and 12.6 mils of Gd. For POSS we assume 60 mils of silica and 3 mils of Gd. Thermal neutrons where modeled using straightforward cross-sections and Gd density.

Blackbody X-rays

Table 7 shows the attenuation for 4 Black Body temperatures for three different materials all 63 mils thick. As can be seen, the Space Micro W—Gd shield has roughly a 2× improvement over pure W for the low temperature spectrum and a 3× improvement for the 10 keV spectrum. The Space Micro W—Gd material has between 7 to 4 orders of better shielding performance than POSS-Gd for Black body X-rays.

TABLE 7
Comparison of Black-Body X-ray Attenuation of 3 materials

| | | W—Gd | Pure W | POSS-Gd | W—Gd | Pure W | POSS-Gd |
|---|---|---|---|---|---|---|---|
| BB Temp | Initial dose | Final Dose | Final Dose | Final Dose | Reduction ratio | Reduction ratio | Reduction ratio |
| keV | rad(Si) | rad(Si) | rad(Si) | rad(Si) | (final/initial dose) | (final/initial dose) | (final/initial dose) |
| 3 | 5.7E+6 | 1.6E−4 | 2.8E−4 | 1.5E+3 | 2.8E−11 | 4.9E−11 | 2.7E−4 |
| 5 | 1.9E+6 | 2.6E−2 | 9.5E−2 | 6.0E+3 | 1.4E−8 | 5.1E−8 | 3.2E−3 |
| 8 | 6.2E+5 | 0.52 | 1.85 | 9.0E+3 | 8.4E−7 | 3.0E−6 | 1.5E−2 |
| 10 | 3.5E+5 | 0.99 | 3.33 | 8.7E+3 | 2.8E−6 | 9.4E−6 | 2.5E−2 |

Simulated Environments and Analysis

SMI has provided predictive modeling of the candidates for radiation attenuation, using the Testable Hardware Toolkit (THTk), provided by the Defense Threat Reduction Agency (DTRA). The shielding properties of the samples were simulated using DTRA's Testable Hardware Toolkit (THTk) software. The Testable Hardware Toolkit (THTk) is a nuclear survivability analysis and modeling tool.⁵

Neutron Shielding Performance

Background: High-energy neutrons (a few MeV) undergo inelastic reactions, which produce recoils and secondary particles. Neutrons with energies in the keV range interact with atoms primarily through elastic collisions, and recoil atoms. Thermal neutrons are in the eV range.

Neutron shielding calculations are dependent on the energies of the neutrons. Thermal neutrons (<0.025 eV) can be captured while fast neutrons require moderation or slowing down through multiple interactions with atoms.

Thermal Neutron Shielding Calculations

Gd-155 and Gd-157 make up 14.8% and 15.65% of natural Gd and have a thermal neutron cross-section of 60 000 and 255 000 barns respectively. We assumed the average Gd composition cross-section of 48,890 which is less assuming that a natural composition Gd was used.

Space micro W—Gd material has a density of 3.5E21 Gd atoms/cm³ while the POSS with one Gd atom has a density of Gd of 1.2E21 Gd atoms m³. Therefore it can be expected that the thermal neutron shielding effectiveness of the Space Micro material is about twice as effective at shielding thermal neutrons then the Gd loaded POSS.

Exposure to thermal neutrons creates a (n, gamma) reaction converting the isotopes to stable even-numbered isotopes. Gamma emissions are up to 8.5 MeV on ¹⁵⁷Gd and up to 7.9 MeV for ¹⁵⁵Gd. Additionally internal conversion electrons (Auger electrons) in the range of 41 keV and below are produced.

Our assumptions for shielding effectiveness are based on thermal neutron shielding. The input values are shown in table 8

TABLE 8
Constants for Neutron shielding calculations

| Name | Number | Units | Symbol |
|---|---|---|---|
| Gd Cross section Thermal | 48890 | Barns | GdTXsect |
| Gd Cross section Thermal | 4.889E−20 | cm2 | S |
| Thickness of shield (cm) | 0.16002 | cm | T |
| Gd Loading | 20 | % | % |
| Atoms/cm3 | 2.69E+19 | atoms/cm3 | N |

For this back of the envelope calculation we assumed that the reduction in neutron flux would be proportional to: Gd cross-section*thickness of the shield*proportion of Gd*the number of atoms or
S*T*%*N (1)
The result is a four-fold reduction in thermal neutron flux using the above equation.
Comparison of Shielding Effectiveness to POSS

Polyhedral Oligomeric Silsesquioxanes or POSS allows for one or more metals to be added for shielding purposes. Spratt describes the effectiveness of thermal neutron shielding using POSS. Using TART and a weight fraction of 0.5 Gd: POSS, 1 mm of shielding reduced the thermal neutron flux to 32% of the incident dose. 1.5 mm (˜60 mils) of material would reduce the thermal neutron flux to 20% of the incident dose. This is comparable to the reduction calculated for the Space Micro shield using 20% Gd loading. Spratt used a more exact calculation using TART. Based on the 2 to one density ratio of Gd in the Space Micro shield material versus the POSS material, it is quite possible that the Space Micro material would actually have a 2× higher attenuation if a more exact TART calculation was performed.

Shielding Comparisons

Table 7 shows the attenuation for 4 Black Body temperatures for three different materials all 63 mils thick. As can be seen, the Space Micro W—Gd shield has roughly a 2× improvement over pure W for the low temperature spectrum and a 3× improvement for the 10 keV spectrum. The Space Micro W—Gd material has between 7 to 4 orders of better shielding performance then POSS-Gd for Black body X-rays.

Graph 3 and Graph 4 show the Blackbody attenuation curves for the Space Micro W—Gd shielding material for a 3 keV and 10 keV spectrum. The sharp rise at 50 mils is the boundary between the W and Gd material. The actual material is intermixed so there would be no inhomogeneity in the dose deposition profile.

Embodiments of the invention may be optimized for a material for the attenuation of Blackbody X-rays as well as thermal neutrons, thus shielding high speed aerospace systems from pulsed, man-made weapon X-ray radiation. The material is both strong and thin and provides the radiation shielding while withstanding high thermal and mechanical shock from flight and incident radiation. Further, Embodiments of the invention are to be employed within a composite structure in space related or high altitude (exoatmospheric) applications.

US Patent References:

| | | | |
|---|---|---|---|
| 1. | 5,889,316, | May 1999 | Strobel, et al |
| 2. | 6,858,795, | February 2005 | Czajkowski et al |
| 3. | 60/679,537, | May 2005 | Featherby et al |
| 4. | 5,635,754 | June 1997 | Strobel et al |
| 5. | 5,825,042 | October 1998 | Strobel et al |
| 6. | 5,899,316 | March 1999 | Strobel et al |
| 7. | 6,261,508 B1 | July 2001 | Featherby et al |
| 8. | 6,455,864 B1 | September 2002 | Featherby et al |
| 9. | 6,583,432 | June 2003 | Featherby et al |
| 10. | 6,720,493 B1 | April 2004 | Strobel et al |
| 11. | 4,795,654 | | Teleki et al |

Other References:

1. Space Micro Inc., MDA04-212 Proposal, “Radiation shielding”, June 2004

2. P. Layton, “Radiation Shielding of COTS Electronics”, Internal Correspondence, 2005

3. Maxwell Technologies, www.maxwell.com/microelectronics/applications/space.html

4. HETC radiation transport code development for cosmic ray shielding applications in space W. Townsend, T. M. Miller and Tony A. Gabriel, Department of Nuclear Engineering, University of Tennessee, Knoxville, Tenn. 37996-2300, USA Scientific Investigation & Development, Knoxville, Tenn. 37922, USA

5. Dual Purpose Effective Radiation Shielding Materials for Space Mission Applications, Zeev Shayer and Robert C. Amme, Department of Physics and Astronomy, University of Denver, 2112 E. Wesley Ave., Denver, Colo. 2000

6. Total Dose and Single Event Effects Testing of a commercial 0.8 μm CMOS gate array process, Feingold and P. Layton, Space Electronics Inc., 2000

7. Space Micro Inc., MDA04-212 Proposal, “Radiation shielding”, June 2004

8. P. Layton, “Radiation Shielding of COTS Electronics”, Internal Correspondence, 2005

9. Provisional Patent Application No. 60/679,537, Featherby et al, May 2005

10. www.dingerceramics.com/XLfnlnfo.htm

11. www.intelligensys.co.uk/sim/macropac.htm

12. www.dingerceramics.com/public.htm

13. www.inderscience.com/search/index.php?action=record&

14. www.dtra.mil/toolbox/directorates/td/tdn/tdna/thtk.cfm

15. www.gaeinc.com/puff-tft.pdf

16. Testable Hardware Toolkit (THTk), Defense Threat Reduction Agency (DTRA)

17. http://composite.about.com/library/glossary/s/bldef-s4975.htm

18. PUFF-TFT materials database (electronic file, provided with the PUFF-TFT distribution).

19. W. H. Childs, “Thermophysical Properties of Selected Space-Related Materials”, TOR-0081(6435-02)-1 Volumes 1 and 2, Aerospace Corporation, Los Angeles Calif. February 1981.

20. W. H. Childs, “Thermophysical Properties of Selected Space-Related Materials”, TR-2002(8565)-7, Aerospace Corporation, Los Angeles Calif. September 2002.

21. Meis, A. K. Froment and D Moulinier. “Determination of Gadolinium Thermal Conductivity Using Experimentally Measured Values of Thermal Diffusivity.” J. Phys. D: Appl. Phys. 26 (1993). 560-562.

22. J. Spratt, S Aghara, B. Fu, J. Lichtenhan, and R. Leadon, “A Conformal Coating for Shielding Against Naturally Occurring Thermal Neutrons”, IEEE TRANSACTIONS ON NUCLEAR SCIENCE, VOL. 52, NO. 6, DECEMBER 2005, pp 2340-2344.

23. “TART Is a Forward Monte Carlo Code for Calculating Neutron Transport Through Materials,” TART, Lawrence Livermore Nat. Lab. Rep. UCRL-ID-126 455, 2002. Rev. 4.

24. “MCNPX User's Manual: Version 2.4.0,” Los Alamos National Laboratory, LA-CP-02-408, 2002.

1. A radiation-shield filler composition, comprising a high Z metals, and at least 3% by volume of an effective neutron attenuator.

2. A radiation-shield filler composition according to claim 1, wherein said effective neutron attenuator is selected from the group consisting of boron and gadolinium.

3. A radiation-shielding filler composition according to claim 2, wherein said high Z metal comprises tungsten.

4. A radiation-shield filler composition according to claim 3, wherein said composition comprises a binder.

5. A radiation-shield composition according to claim 3, wherein said effective neutron attenuator comprises gadolinium.

6. A radiation-shield composition according to claim 5, wherein said gadolinium comprises passivated gadolinium

7. A radiation-shield composition according to claim 6 wherein said passivated gadolinium comprises particles coated by atomic deposition.

8. A radiation-shield composition according to claim 7, wherein said binder comprises a partially cured adhesive.

9. A radiation-shield composition according to claim 8, further comprising a modifier to control rheological characteristics of said filler.

10. A radiation-shield composition according to claim 7, further comprising a modifier to control rheological characteristics of said filler.

11. A radiation-shielding filler composition according to claim 5, comprising 20%-40% Gadolinium and 80%-20% tungsten by volume of metal in the composition.

12. A radiation-shielding filler composition according to claim 11, comprising 23%-37% Gadolinium and 77%-63% tungsten.

13. A radiation-shield composition according to claim 1, wherein said high Z metal comprises tungsten

14. A radiation shield comprising a radiation-shield composition according to claim 8.

15. A radiation shield according to claim 14, further comprising a sensor embedded therein.

16. A radiation resistant structure comprising a shield according to claim 14.
A1. An article comprising, a. adhesive b. filler c. modifier. Embodiments of the invention will be a composite material, consisting of primarily filler by volume, with the adhesive and any modifier agents filling the space between the filler particles. Typical filler materials are Tungsten, Boron, Titanium, Gadolinium, Lead, Hafnium, Polyethylene, Titanium, Aluminum or Gold. Typical adhesives may include those materials used within the structural composition, such as Epoxy, Bismalemide, Cyanate Ester or other related materials, modifiers might include materials to alter the viscosity and therefore workability of the composite, such as fumed silica, or alumina powder.
A2. An article, according to claim 1, utilizing Gadolinium powder with a nano-scale oxide coating that mitigates reactivity and provides negligible changes to density.
A3. An article, according to claims 1 that can be filled with multiple fillers to provide protection from multiple radioactive species, such as X-ray and thermal neutrons, using Tungsten and Gadolinium, Tungsten and Aluminum, or any combination of materials mentioned in claim 1.
A4. An article, according to claim 1, that can provide radiation protection as an integral structure within a spacecraft.
A5. An article, according to claim 1 that can provide fabrication flexibility through multiple ways, such as b-staging, stenciling, or as a putty.
A6. An article, according to claim 1 that maximizes packing density of the fillers to provide optimal radiation shielding attenuation through proper filler particle size distribution (PSD) selection.
A7. An article, according to claim 6, that employs novel processing techniques to optimize the article density, via compaction and densification, through the use of a fugitive solvent, vibration, particle size distribution or a combination of these techniques.
A8. An article, according to claim 1, that combines Tungsten, between 60% and 100% of filler and Gadolinium, between 0% and 40% of filler by weight in optimal ratios to maximize radiation attenuation and shielding for black body X-ray and thermal neutron radiation, while optimizing process workability.
A9. An article, according to claim 1 that may incorporate fumed silica, not to exceed 3% by weight, as a theological additive, to assist in the homogeneous distribution of fillers during cure.
